(19) United States
(12) Patent Application Publication
(10) Pub. No.: US 2017/0222260 A1
(43) Pub. Date: Aug. 3, 2017

(54) SOLID ELECTROLYTE POWDER, ALL-SOLID-STATE LITHIUM ION SECONDARY BATTERY, AND METHOD OF MANUFACTURING SOLID ELECTROLYTE POWDER

(71) Applicant: ALPS ELECTRIC CO., LTD., Tokyo (JP)

(72) Inventors: Takashi HATANAI, Tokyo (JP); Akio HANADA, Tokyo (JP); Shunetsu SATO, Tokyo (JP); Shin KINOUCHI, Tokyo (JP); Mika SASAKI, Tokyo (JP)

(21) Appl. No.: 15/490,986

(22) Filed: Apr. 19, 2017

Related U.S. Application Data
(63) Continuation of application No. PCT/JP2015/073483, filed on Aug. 21, 2015.

(30) Foreign Application Priority Data
Oct. 20, 2014 (JP) 2014-213295

(51) Int. Cl. H01M 10/0562; C01B 25/45; H01M 10/0525

(52) U.S. Cl. CPC H01M 10/0562; H01M 10/0525; C01B 25/45; H01M 2300/0068; C01P 2006/40; C01P 2002/60; C01P 2004/62

(57) ABSTRACT

A solid electrolyte powder includes ion-conductive LATP powder that is obtained by heating and melting raw materials at a predetermined temperature to prepare molten LATP mixture, cooling the molten LATP mixture to prepare a crystalline material having a NASICON structure, crushing the crystalline material to prepare crystal powder having a particle size of 1 μm to 10 μm, and performing a heat treatment on the crystal powder in air at a temperature of 800° C. to 1000° C. for a predetermined period of time.

### CLAIM OF PRIORITY

This application is a Continuation of International Application No. PCT/JP2015/073483 filed on Aug. 21, 2015, which claims benefit of Japanese Patent Application No. 2014-213295 filed on Oct. 20, 2014. The entire contents of each application noted above are hereby incorporated by reference.

### BACKGROUND OF THE DISCLOSURE

1. Field of the Disclosure

The present disclosure relates to solid electrolyte powder, an all-solid-state lithium ion secondary battery in which the solid electrolyte powder is used, and a method of manufacturing solid electrolyte powder.

2. Description of the Related Art

A lithium ion battery is superior because it can obtain a higher energy density than batteries in which other materials are used. However, in lithium ion batteries which have been put into practice, an electrolyte is an organic electrolytic solution. Therefore, it is difficult to reduce the size and thickness of a battery, and liquid leakage or firing may occur.

On the other hand, in a case where a lithium-ion-conductive solid electrolyte is used, the possibility of liquid leakage or firing can be reduced, and a reduction in the size and the thickness of a battery can be realized. Therefore, the energy density per volume can be significantly improved.

For example, in a battery described in Japanese Patent No. 3012211, a lithium-ion-conductive glass ceramic as an ion-conductive solid electrolyte is manufactured according to the following procedure. First, NH₄H₂PO₄, SiO₂, TiO₂, Al(OH)₃, and Li₂CO₃ are heated and melted in an electrical furnace. Here, the raw materials are decomposed at 700° C. to vaporize CO₂, NH₃, and H₂O components and are further heated to 1450° C. to be further melted. The glass melt prepared as described above is cast on a sheet plate to prepare sheet-shaped glass, and the sheet-shaped glass is annealed at 550° C. to remove distortion. Next, the glass is cut into a predetermined size and polished. Next, a heat treatment is performed on the cut and polished glass at 800° C. for 12 hours and at 1000° C. for 24 hours to prepare a glass ceramic. Crystals deposited by this heat treatment have a structure represented by Li_{1+X+Y}Al_{X}Ti_{2-X}Si_{Y}P_{3-Y}O₁₂ and have high conductivity.

However, in the steps of manufacturing a battery described in Japanese Patent No. 3012211, a cooling device is used for cooling high-temperature glass melt to prepare glass. Therefore, there are problems in that introduction costs and an installation space are required for the cooling device.

### SUMMARY OF THE DISCLOSURE

The present disclosure provides: a solid electrolyte powder with which a small and thin lithium ion battery can be manufactured and a desired conductivity can be realized without introducing a new cooling device; and an all-solid-state lithium ion secondary battery in which the solid electrolyte powder is used.

A solid electrolyte powder according to an aspect of the present invention includes ion-conductive LATP powder that is obtained by heating and melting raw materials at a predetermined temperature to prepare molten LATP mixture, cooling the molten LATP mixture to prepare a crystalline material having a NASICON structure, crushing the crystalline material to prepare crystal powder having a particle size of 1 μm to 10 μm, and performing a heat treatment on the crystal powder in air at a temperature of 800° C. to 1000° C. for a predetermined period of time.

As a result, a small and thin lithium ion battery can be manufactured without introducing a new cooling device. Further, the crystalline material is crushed to prepare crystal powder, and a heat treatment is performed on the crystal powder under predetermined conditions. As a result, LATP powder having a desired conductivity can be obtained.

In the solid electrolyte powder according to the aspect, it is preferable that a crystallite size on a predetermined lattice plane of the LATP powder after the heat treatment is 500 nm or less.

In this case, the predetermined lattice plane refers to, for example, a (134) plane, and by reducing the crystallite size, the ion conductivity of the LATP powder can be increased.

It is preferable that the solid electrolyte powder according to the aspect includes secondary powder having a particle size of 100 nm to 1000 nm that is obtained by crushing the LATP powder.

By reducing the particle size, the ion conductivity can be further increased.

It is preferable that the solid electrolyte powder according to the aspect includes tertiary powder that is obtained by performing a heat treatment again on the secondary powder at a temperature of 300° C. to 700° C. for a predetermined period of time.

By performing the heat treatment again, the ion conductivity can be further increased.

In the solid electrolyte powder according to the aspect, it is preferable that a composition of the LATP powder is represented by Li₁₊ₓAlₓTi₂₋ₓ(PO₄)₃. Here, x satisfies 0<x≦0.5.

In an all-solid-state lithium ion secondary battery according to another aspect of the present invention, any one of the above-described solid electrolyte powders is used.

By using the above-described solid electrolyte powder, a small and thin lithium ion secondary battery having desired performance can be realized.

A method of manufacturing solid electrolyte powder according to still another aspect of the present invention includes: a step of heating and melting raw materials at a predetermined temperature to prepare molten LATP mixture; a step of naturally cooling the molten LATP mixture to prepare a crystalline material having a NASICON structure; a step of crushing the crystalline material to prepare crystal powder having a particle size of 1 μm to 10 μm; and a step of performing a heat treatment on the crystal powder in air at a temperature of 800° C. to 1000° C. for a predetermined period of time to prepare ion-conductive LATP powder.

As a result, a small and thin lithium ion battery can be manufactured without introducing a new cooling device. Further, the crystalline material is crushed to prepare crystal powder, and a heat treatment is performed on the crystal powder under predetermined conditions. As a result, LATP powder having a desired conductivity can be obtained.

### BRIEF DESCRIPTION OF THE DRAWINGS

FIG. 1 is a schematic diagram showing a configuration of an all-solid-state lithium ion secondary battery according to an embodiment of the present invention;

FIG. 2 is a graph showing the results of X-ray diffraction in Example 1;

FIG. 3 is a graph showing the results of X-ray diffraction in Example 2;

FIG. 4 is a graph showing the results of X-ray diffraction in Comparative Example 1;

FIG. 5 is a graph showing a relationship between a temperature of a heat treatment during the preparation of LATP powder and a crystallite size; and

FIG. 6 is a graph showing a relationship between a crystallite size and an ion conductance.

### DETAILED DESCRIPTION OF THE DISCLOSURE

Hereinafter, a solid electrolyte powder, an all-solid-state lithium ion secondary battery, and a method of manufacturing solid electrolyte powder according to an embodiment of the present invention will be described with reference to the drawings.

### Configuration of All-Solid-State Lithium Ion Secondary Battery

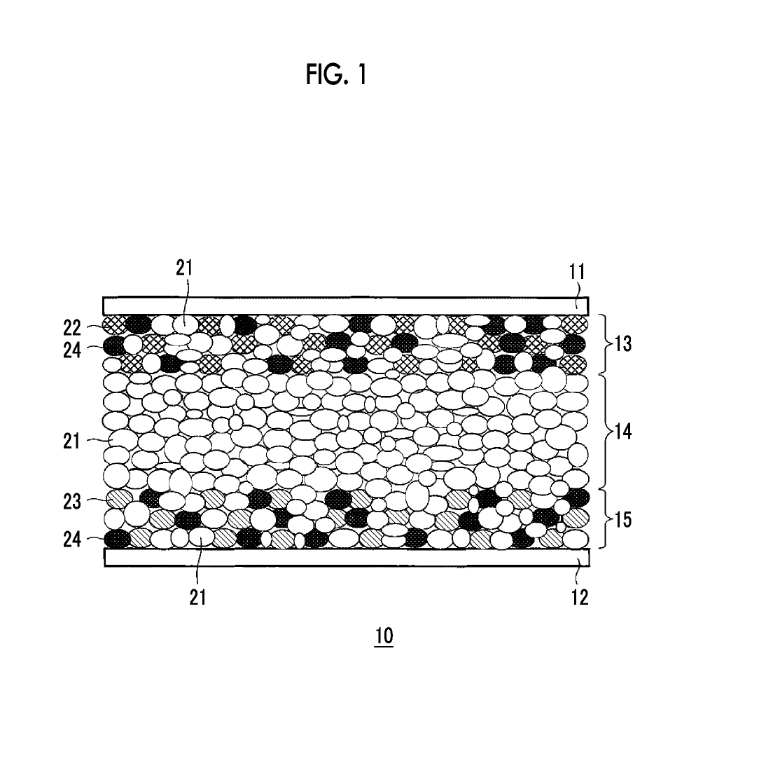

FIG. 1 is a schematic diagram showing a configuration of an all-solid-state lithium ion secondary battery 10 according to the embodiment. The all-solid-state lithium ion secondary battery 10 has a configuration in which a negative electrode layer 13, a solid electrolyte layer 14, and a positive electrode layer 15 are formed between a pair of a negative electrode current collector 11 and a positive electrode current collector 12 in order from the negative electrode current collector 11 to the positive electrode current collector 12. The negative electrode current collector 11 is connected to a negative electrode (not shown), and the positive electrode current collector 12 is connected to a positive electrode (not shown). Due to this configuration, chemical energy generated from the inside of the battery 10 can be extracted from the positive electrode and the negative electrode to the outside as electrical energy.

The negative electrode layer 13 has a configuration in which solid electrolyte particles 21 (solid electrolyte powder), an electrode active material 22, and conductive auxiliary agent particles 24 are mixed. The solid electrolyte layer 14 is formed of the solid electrolyte particles 21. The positive electrode layer 15 has a configuration in which the solid electrolyte particles 21, an electrode active material 23, and the conductive auxiliary agent particles 24 are mixed. A mixing ratio between the materials in each of the negative electrode layer 13 and the positive electrode layer 15 can be set based on the specification of the battery and the like.

As a material of the negative electrode current collector 11, for example, copper is used. As a material of the positive electrode current collector 12, for example, aluminum is used. In addition, as the electrode active material 22 of the negative electrode layer 13, for example, graphite, hard carbon, carbon nanotubes, fullerene, or other carbon materials can be used. As the electrode active material 23 of the positive electrode layer 15, for example, lithium nickel oxide, lithium cobalt oxide, or other lithium metal oxides can be used. As a material of the conductive auxiliary agent particle 24, for example, activated carbon, graphite particles, or carbon fibers can be used. The solid electrolyte particles 21 (solid electrolyte powder) will be described below in detail.

### Configuration of Solid Electrolyte Particles 21 (Solid Electrolyte Powder) and Method of Manufacturing the Same

The solid electrolyte particle 21 will be described below in the manufacturing step order.

### (1) Preparation of Molten LATP Mixture

As starting materials, for example, H₃PO₄, NH₄H₂PO₄, Li₂CO₃, TiO₂, Al(OH)₃, or Al₂O₃ can be used. In addition, from the viewpoint of uniformity of NASICON crystals, it is preferable that the starting materials do not include SiO₂.

These raw materials are put into a heating container and are heated and melted at a temperature which are equal to or higher than melting points of the raw materials, for example, at 1500° C. for a predetermined period of time to prepare molten LATP mixture.

### (2) Preparation of Crystalline Material

The molten LATP mixture prepared in (1) described above is cooled to prepare a crystalline material having a NASICON structure. Regarding the cooling, the molten LATP mixture is naturally cooled, for example, by bringing the heating container into contact with a metal plate (for example, a stainless steel plate) to radiate heat. Here, in general, the NASICON structure refers to a structure of a compound represented by M₂(XO₄)₃ where MO₆ octahedra and XO₄ tetrahedra sharing vertices are three-dimensionally arranged, M represents a transition metal, and X represents S, P, As, Mo, or W.

### (3) Preparation of Crystal Powder

The crystalline material prepared in (2) described above is crushed using, for example, a mortar or a pestle to prepare crystal powder. The crushing is performed such that the average particle size of the crystalline material is in a range of 1 μm to 10 μm.

### (4) Preparation of LATP Powder

The crystal powder prepared in (3) described above is put into a gas muffle furnace, and a heat treatment (hereinafter, also referred to as “primary heat treatment”) is performed on the crystal powder in air at a predetermined temperature for a predetermined period of time to prepare LATP powder. Due to this heat treatment, highly ion-conductive LATP powder can be obtained in which a crystallite size on a predetermined lattice plane (for example, a (134) plane) or a (300) plane) is 500 nm or less. With this LATP powder, solid electrolyte powder is formed.

Here, preferable conditions of the primary heat treatment are a temperature of higher than 700° C. and lower than 1000° C. and a time of 1 hour to 12 hours. The temperature of the primary heat treatment is more preferably 800° C. or higher.

A composition of the prepared LATP powder is represented by, for example, Li₁₊ₓAlₓTi₂₋ₓ(PO₄)₃, in which x satisfies 0<x<0.5.

The solid electrolyte powder can be prepared through the above-described steps (1) to (4), and it is more preferable that the following steps (5) and (6) are performed from the viewpoint of increasing the ion conductivity.

### (5) Preparation of Secondary Powder

The LATP powder prepared in (4) described above is crushed using, for example, a mortar or a pestle to prepare secondary powder having an average particle size of 100 nm to 1000 nm.

### (6) Preparation of Tertiary Powder

A heat treatment (hereinafter, also referred to as “secondary heat treatment”) is performed again on the secondary powder prepared in (5) described above to prepare tertiary powder. After putting the secondary powder into, for example, a gas muffle furnace, the heat treatment is performed on the secondary powder in air at a predetermined temperature (for example, 300° C. to 700° C.) for a predetermined period of time (for example, 30 minutes to 12 hours). Due to this heat treatment, the ion conductivity can be further increased.

Hereinafter, Examples will be described. Preparation of Samples

(a) Starting materials of each Example were H₃PO₄, Li₂CO₃, TiO₂, and Al₂O₃, and a composition of the respective components present in a mixture of the starting materials is as follows in terms of oxides. Here, “the composition in terms of oxides” represents a composition that represents, assuming that all the starting materials were decomposed and changed into oxides during melting, the contents of the respective components in the molten mixture with respect to 100 mol % of the total amount of all the produced oxides.
(a-1) Example 1

Li₂O: 16.2 mol %

Al₂O₃: 3.8 mol %

TiO₂: 42.5 mol %

P₂O₃: 37.5 mol %

SiO₂: 0 mol %

(a-2) Example 2

Li₂O: 18.3 mol %

Al₂O₃: 3.6 mol %

TiO₂: 41.5 mol %

P₂O₃: 36.6 mol %

SiO₂: 0 mol %

After the starting materials were mixed with each other using a mortar, a frit was prepared according to the following procedure.

The mixture was heated at 300° C. for 30 minutes and at 700° C. for 30 minutes, was further heated at 1100° C. for 15 minutes, and was extracted and naturally cooled.

### (b) Conditions of Heating and Melting for Preparing Molten LATP Mixture

For pre-heating, the mixture was heated at 1100° C. for 20 minutes and then was heated at 1300° C. for 10 minutes.

Next, for main heating, the raw materials were heated at 1500° C., as a temperature at which the raw materials were melted, for 5 minutes.

### (c) Conditions of Preparing Crystalline Material

The molten LP mixture of the heating container was cast on a stainless steel plate having a thickness of 20 mm and was naturally cooled.

### (d) Preparation of Crystal Powder

The crystalline material was crushed using a mortar such that the average particle size of the crystalline material was in a range of 1 μm to 10 μm.

### (e) Preparation of LATP Powder (Solid Electrolyte Powder)

Using a gas muffle furnace HPM-1G (manufactured by Matsuura Manufacture Co., Ltd.), a heat treatment was performed in air for 12 hours. The temperature of the heat treatment was set in a range of 700° C. to 950° C. After the heat treatment, the powder was naturally cooled.

Through the above-described steps, LATP powder according to Example 1 having a configuration represented by Li_{1.3}Al_{0.3}Ti_{1.7}(PO₄)₃ was obtained, and LATP powder according to Example 2 having a configuration represented by Li_{1.5}Al_{0.3}Ti_{1.7}(PO₄)₃ was obtained.

### (f) Preparation of Comparative Examples

After performing the manufacturing steps (a) to (e) on the same starting materials as those in Example 1, the heat treatment of the step (e) was not performed. As a result, a sample according to Comparative Example 1 was prepared. After performing the manufacturing steps (a) to (e) on the same starting materials as those in Example 2, the heat treatment of the step (e) was not performed. As a result, a sample according to Comparative Example 2 was prepared.

### Evaluation Method

### (a) X-Ray Diffraction (XRD)

Using a focusing diffractometer, X-ray diffraction was performed under the following conditions.

Target: Cu

Tube Voltage: 45 kV

Tube Current: 40 mA

Measurement Range: 10° to 100°

Step Size: 0.016°

T/S: 0.5 s

Incidence Side: FDS

Detector Side: XC

Stage: flat sample

### (b) Evaluation of Impedance Properties

Each of a sample having undergone the heat treatment (primary heat treatment) and a sample not having undergone the heat treatment was crushed using a mortar to prepare a powder pellet, and the powder pellet was interposed between copper plate electrodes to measure an impedance thereof. The measurement was performed in a dry nitrogen atmosphere at 25° C., and the ion conductance was calculated based on a drawing created from a Nyquist plot of the measurement result. Evaluation Results

### (a) X-Ray Diffraction

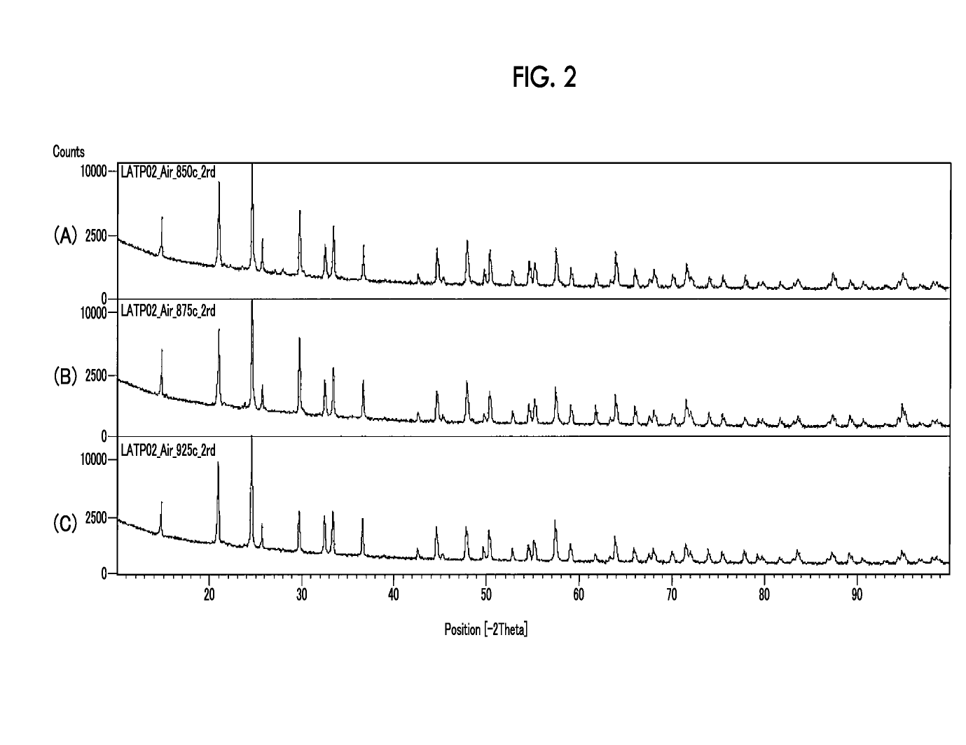

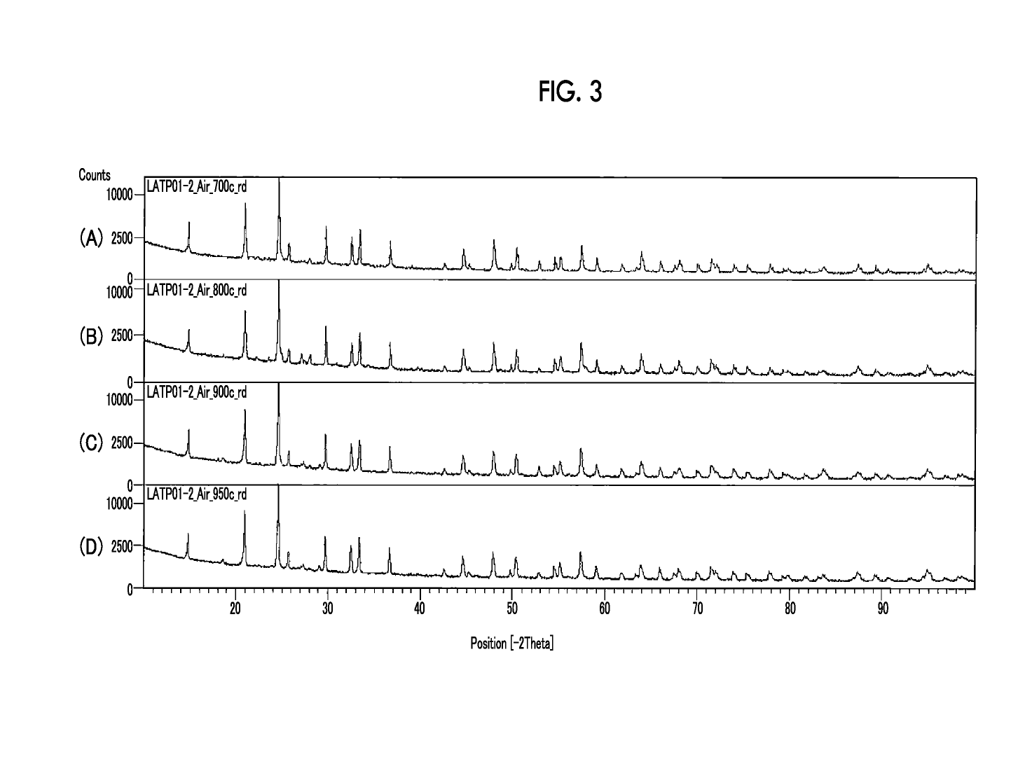

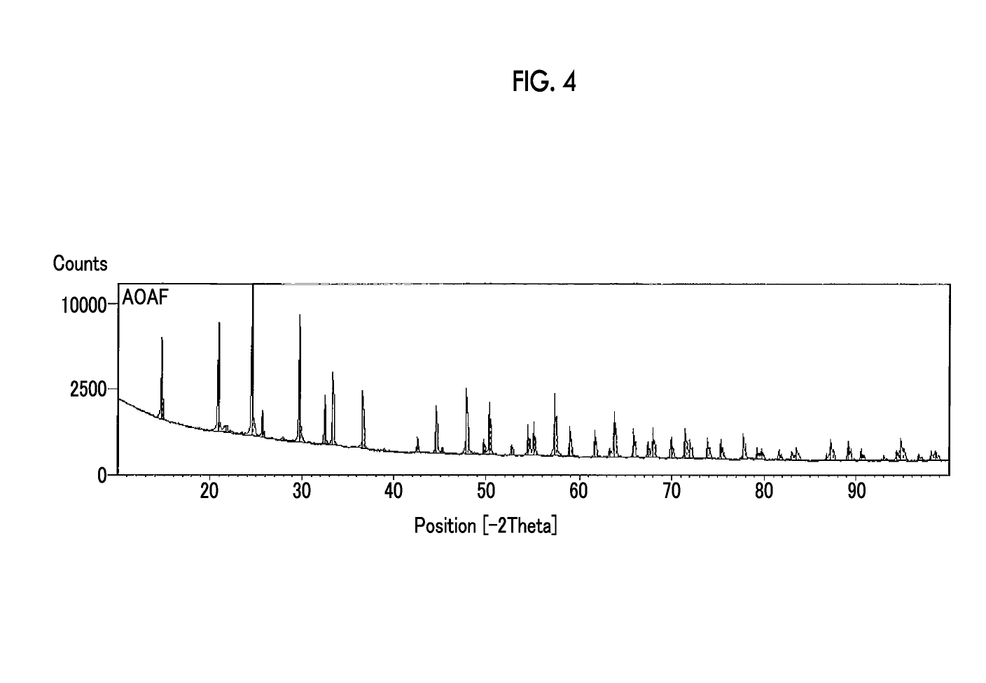

FIG. 2 is a graph showing the results of X-ray diffraction in Example 1. FIG. 3 is a graph showing the results of X-ray diffraction in Example 2. FIG. 4 is a graph showing the results of X-ray diffraction in Comparative Example 1. In FIGS. 2 to 4, the horizontal axis represents an incidence angle, and the vertical axis represents a diffraction intensity. In addition, in FIG. 2, (A), (B), and (C) represent cases where the temperature of the primary heat treatment is 850° C., 875° C., and 925° C., respectively. In FIG. 3, (A), (B), (C), and (D) represent cases where the temperature of the primary heat treatment is 700° C., 800° C., 900° C., and 950° C., respectively.

Regarding (A) to (C) of FIG. 2, (A) to (D) of FIG. 3, and FIG. 4, the diffraction peak of LiTi₂(PO₄)₃ having a NASICON structure was measured. As a result, it was found that the NASICON structure was maintained before and after the heat treatment, and it was also found that, in at least a temperature range shown in FIGS. 2 and 3, the NASICON structure was maintained irrespective of the temperature of the heat treatment.

### (b) Measurement of Impedance

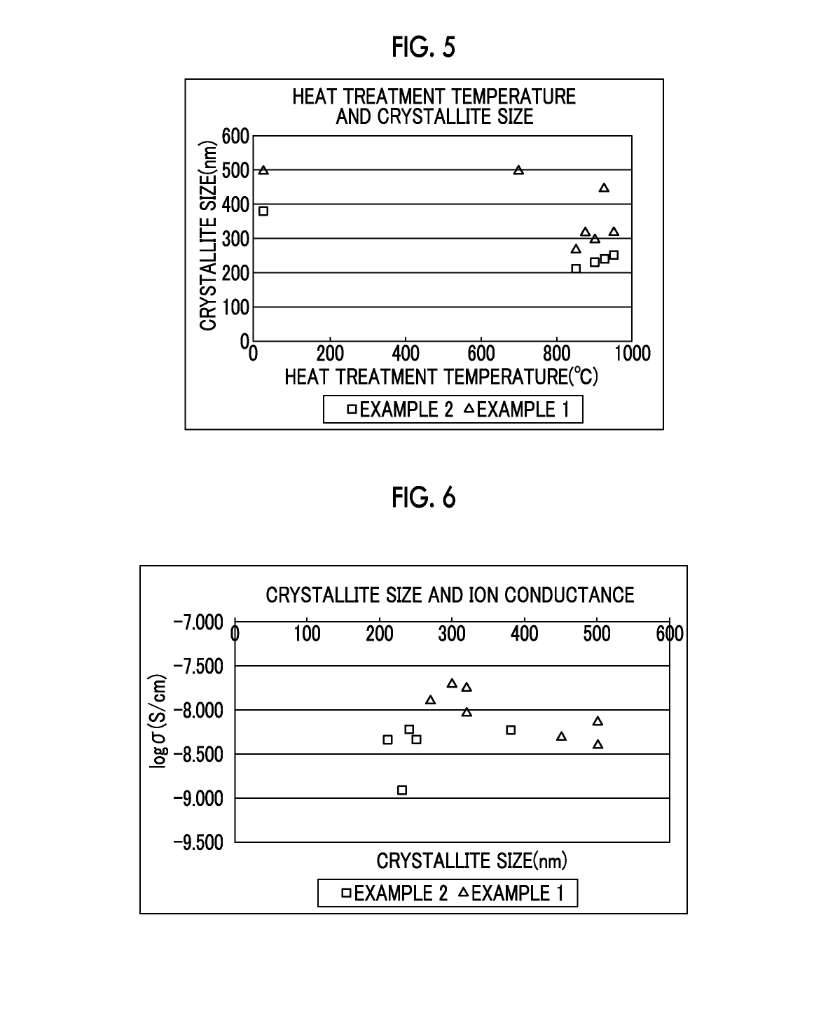

FIG. 5 is a graph showing a relationship between a temperature of the heat treatment (primary heat treatment) during the preparation of LATP powder and a crystallite size.

FIG. 6 is a graph showing a relationship between a crystallite size and an ion conductance. Tables 1 and 2 show measured values of Examples 1 and 2 and Comparative Examples 1 and 2 in a case where the temperature of the heat treatment (primary heat treatment) was changed, and FIGS. 5 and 6 were created based on the measured values. In FIGS. 5 and 6, the crystallite size refers to a size (unit: nm) on a (134) plane. The ion conductance on the vertical axis of FIG. 6 refers to a natural logarithm of a measured ion conductance σ (unit: Siemens/cm).

TABLE 1

| | Heat | Lattice Constant | | Unit Volume | Crystallite Size | | |
|---|---|---|---|---|---|---|---|
| | Treatment | a | c | V | (nm) | | |
| | Temperature | (ongstrom) | (ongstrom) | (ongstrom\hat{ }3) | (113) | (300) | (134) |
| Comparative | Not | 8.4974 | 20.7885 | 1299.9 | 740 | 900 | 500 |
| Example 1 | Performed | | | | | | |
| Example 1 | 700° C. | 8.5026 | 20.9257 | 1310.1 | 710 | 580 | 500 |
| | 850° C. | 8.4964 | 20.8012 | 1300.4 | 390 | 420 | 270 |
| | 875° C. | 8.4958 | 20.7815 | 1299.0 | 500 | 620 | 320 |
| | 900° C. | 8.4986 | 20.8023 | 1301.2 | 650 | 870 | 300 |
| | 950° C. | 8.4980 | 20.8010 | 1300.9 | >Max | 580 | 320 |
| Comparative | Not | 8.4984 | 20.8021 | 1301.1 | 850 | 460 | 380 |
| Example 2 | Performed | | | | | | |
| Example 2 | 850° C. | 8.5004 | 20.8213 | 1302.9 | 850 | 550 | 210 |
| | 900° C. | 8.4969 | 20.7886 | 1299.8 | 850 | 350 | 230 |
| | 925° C. | 8.4973 | 20.7946 | 1300.3 | 900 | 320 | 240 |
| | 950° C. | 8.4968 | 20.7965 | 1300.3 | >Max | 460 | 250 |

TABLE 2

| | Heat | Conductance | |
|---|---|---|---|
| | Treatment Temperature | σ [S/cm] | log σ |
| Comparative Example 1 | Not Performed | 4.03E−09 | −8.395 |
| Example 1 | 700° C. | 7.47E−09 | −8.127 |
| | 850° C. | 1.30E−08 | −7.886 |
| | 875° C. | 1.82E−08 | −7.740 |
| | 900° C. | 2.02E−08 | −7.695 |
| | 950° C. | 9.39E−09 | −8.027 |
| Comparative Example 2 | Not Performed | 5.80E−09 | −8.237 |
| Example 2 | 850° C. | 4.55E−09 | −8.342 |
| | 900° C. | 1.20E−09 | −8.921 |
| | 925° C. | 5.92E−09 | −8.228 |
| | 950° C. | 4.56E−09 | −8.341 |

As shown in Table 1, the crystallite size of Example 1 was less than that of Comparative Example 1, and the crystallite size of Example 2 was less than that of

Comparative Example 2. In addition, in Examples 1 and 2, the crystallite sizes on the (134) plane were 500 nm or less, which were obviously less than those in Comparative Examples 1 and 2 where the heat treatment was not performed at a heat treatment temperature of higher than 700° C.

Regarding the conductance, as shown in Table 2 and FIG. 6, the ion conductance was increased depending on the reduction in the crystallite size, and it can be seen that a sufficiently high for an all-solid-state lithium ion secondary battery was realized.

Regarding the lattice constant, as shown in Table 1, the numerical values of Examples 1 and 2 were substantially the same as those in Comparative Examples 1 and 2, and it can be seen that there were no changes depending on the heat treatment or depending on the temperature of the heat treatment.

The present invention has been described with reference to the above-described embodiment. However, the present invention is not limited to the above-described embodiment, and various improvements or modifications can be made for the purpose of improvements or within the scope of the present invention.

As described above, the solid electrolyte powder according to the present invention is small and thin and is practically useful for realizing a lithium ion battery having no possibility of liquid leakage or firing.

It should be understood by those skilled in the art that various modifications, combinations, sub-combinations and alterations may occur depending on design requirements and other factors insofar as they are within the scope of the appended claims of the equivalents thereof.

1. A solid electrolyte powder comprising:
ion-conductive LATP powder that is obtained by heating and melting raw materials at a predetermined temperature to prepare molten LATP mixture, cooling the molten LATP mixture to prepare a crystalline material having a NASICON structure, crushing the crystalline material to prepare crystal powder having a particle size of 1 μm to 10 μm, and performing a heat treatment on the crystal powder in air at a temperature of 800° C. to 1000° C. for a predetermined period of time.

2. The solid electrolyte powder according to claim 1,
wherein a crystallite size on a predetermined lattice plane of the LATP powder after the heat treatment is 500 nm or less.

3. The solid electrolyte powder according to claim 1, comprising:
secondary powder having a particle size of 100 nm to 1000 nm that is obtained by crushing the LATP powder.

4. The solid electrolyte powder according to claim 3, comprising:
tertiary powder that is obtained by performing a heat treatment again on the secondary powder at a temperature of 300° C. to 700° C. for a predetermined period of time.

5. The solid electrolyte powder according to claim 1,
wherein a composition of the LATP powder is represented by Li₁₊ₓAlₓTi₂₋ₓ(PO₄)₃, and
x satisfies 0<x≦0.5.

6. The solid electrolyte powder according to claim 2,
wherein a composition of the LATP powder is represented by Li₁₊ₓAlₓTi₂₋ₓ(PO₄)₃, and
x satisfies 0<x≦0.5.

7. The solid electrolyte powder according to claim 3,
wherein a composition of the LATP powder is represented by Li₁₊ₓAlₓTi₂₋ₓ(PO₄)₃, and
x satisfies 0<x≦0.5.

8. The solid electrolyte powder according to claim 4,
wherein a composition of the LATP powder is represented by Li₁₊ₓAlₓTi₂₋ₓ(PO₄)₃, and
x satisfies 0<x≦0.5.

9. An all-solid-state lithium ion secondary battery
wherein that uses the solid electrolyte powder according to claim 1.

10. A method of manufacturing solid electrolyte powder comprising:
heating and melting raw materials at a predetermined temperature to prepare molten LATP mixture;
naturally cooling the molten LATP mixture to prepare a crystalline material having a NASICON structure;
crushing the crystalline material to prepare crystal powder having a particle size of 1 μm to 10 μm; and
performing a heat treatment on the crystal powder in air at a temperature of 800° C. to 1000° C. for a predetermined period of time to prepare ion-conductive LATP powder.
